(19) United States
(12) Patent Application Publication
(10) Pub. No.: US 2025/0041798 A1
(43) Pub. Date: Feb. 6, 2025

(54) VERSATILE SCRUBBING LIQUID FOR REMOVAL OF CONTAMINANTS FROM A GASEOUS STREAM

(71) Applicant: CLAIRION LTD., Rehovot (IL)

(72) Inventors: Revital MALI, Mevaseret Zion (IL); Zach BARNEA, Jerusalem (IL)

(21) Appl. No.: 18/715,338

(22) PCT Filed: Dec. 1, 2022
(86) PCT No.: PCT/IL2022/051284

§ 371 Date: May 31, 2024

Related U.S. Application Data
(60) Provisional application No. 63/285,102, filed on Dec. 2, 2021.

(51) Int. Cl. B01D 53/78; B01D 53/50; B01D 53/52; B01D 53/56; B01D 53/64; B01D 53/72

(52) U.S. Cl. CPC B01D 53/78; B01D 53/507; B01D 53/52; B01D 53/56; B01D 53/64; B01D 53/72; B01D 2251/106; B01D 2251/108; B01D 2251/506; B01D 2252/30; B01D 2252/504; B01D 2252/602; B01D 2257/302; B01D 2257/304; B01D 2257/404; B01D 2257/556; B01D 2257/602; B01D 2258/0283; B01D 2258/0291; B01D 2258/05

(57) ABSTRACT

Bi-phasic compositions of water-immiscible ionic liquid and aqueous phase for application as versatile scrubbing liquid suitable for decontamination of a contaminated gaseous stream from a variety of contaminants are disclosed. It is currently believed that halogen-assisted catalytic-like oxidation of the contaminants by readily available oxidants in the bi-phasic compositions allows effective decontamination of the gaseous stream.

### CROSS-REFERENCE TO RELATED APPLICATIONS

This application is a National Stage application of International Patent Application No. PCT/IL2022/051284, filed on Dec. 1, 2022, which claims priority to U.S. Provisional Patent Application No. 63/285,102, filed Dec. 2, 2021, each of which is hereby incorporated by reference in its entirety.

### TECHNICAL FIELD

The invention relates to the field of absorption of contaminants from a gaseous stream, such as a natural gas or a flue gas. The invention relates to the use of ionic liquids in oxidative decontamination process of a gaseous stream, in particular from contaminants, such as nitrogen oxides, as well as sulfur dioxide, siloxane, carbon monoxide, hydrogen sulfide, and metals, e.g., heavy metals, or their respective residues. In particular, the invention relates to halogen-, e.g., bromine-mediated oxidation of the variety of contaminants in a gaseous stream with a secondary oxidizer, e.g., hydrogen peroxide, in biphasic system with hydrophobic ionic liquid.

### BACKGROUND

Decontamination of a gaseous stream from various noxious volatile impurities is a laborious task and may require processing the gas with series of consecutive processes to remove each contaminant or small groups of contaminants individually. The flue gas from facilities relying on burning of [hydro]carbon(s), e.g., electric plants, is one type of gas that may contain the burning side-products of the raw materials' impurities, such as sulfur dioxide and various nitrogen oxides (usually designated as NOx, with x indicating the variety of valences of nitrogen atoms in the mixture), whereof of a particular importance is nitric oxide and nitrogen dioxide. Many types of flue gases also contain carbon monoxide. Other contaminants may also include hydrogen sulfide in biogas, and siloxanes, e.g., in biogas and/or in flue gas.

Additionally, so-called sour gas, which is a hydrocarbon source of natural or synthetic origin, contaminated with significant amount of hydrogen sulfide, is evolving as an important source of hydrocarbons, and usually requires decontamination prior to use, or using meticulous means to control sulfur dioxide emission with flue gas.

Some of the impurities may be removed by wet scrubbing process, i.e., by passing the gas though a liquid that reacts with the contaminant but not with the carrier gas. For example, hydrogen sulfide may be successfully trapped with a strong alkaline water solution; however, the disposal of the solution may cause further complications. The removal of sulfur dioxide is conventionally accomplished through the use of the wet flue gas desufurization (WFGD) process, in which the flue gas flows in an upward direction through a suitable tower (e.g. a gas-liquid contactor) and contacts therein with calcium-containing slurry (e.g., limestone). The sulfur dioxide is absorbed in the slurry and is subsequently allowed to react with the calcium compound in a suitable reaction vessel. The by-product thus formed is calcium sulfate. Additionally, ionic liquids have been suggested for use as absorbents in connection with sulfur dioxide; for example, US 2010/0015040 disclose a method for separating and recycling sulfur dioxide from a gaseous mixture by using ionic liquids. Moreover, removal of heavy metals, e.g., mercury, from flue gases, by passing them through a wet scrubber comprising an oxidant, e.g., a halogen, in an ionic liquid, has been disclosed e.g., in PCT patent applications WO 2009/072113 and WO 2013/114350. Recently, selective removal and recovery of nitric acid and/or nitrates into hydrophobic ionic liquid possessing an anion that is (or is displaceable with) nitrate anion was described in WO 2020/115749. A system for trapping hydrogen sulfide from a gaseous stream using an ionic liquid in a wet scrubber, and oxidizing it with an oxidant, e.g., a halogen, in presence of water, was described in WO 2019/202598. The same publication describes that heavy metals can be removed simultaneously with hydrogen sulfide. Halogen reduction from respective halide by hydrogen peroxide and acid was also demonstrated by the publication, in aqueous ionic liquid.

However, there is still a need in the art to provide an efficient process for removing a variety of contaminants simultaneously. There is a specific need in the art to provide a process to remove sulfur dioxide from a gaseous stream in a technologically simple liquid scrubber. There is a further specific need in the art to provide a process to remove nitrogen oxides, e.g., nitric oxide, nitric dioxide, or nitrous oxide, from a gaseous stream.

### SUMMARY

It has now been unexpectedly found that it is possible to remove a variety of contaminants from a gaseous stream using a single scrubbing liquid. As demonstrated in the appended examples, it is possible to remove hydrogen sulfide, mercury, sulfur dioxide, and nitrogen oxides, separately or simultaneously, using the same type of scrubbing liquid.

This versatile scrubbing liquid is a biphasic system of water-immiscible (e.g. hydrophobic) ionic liquid and water. The scrubbing liquid contains a halogen, preferably bromine. As described in greater detail below, the halogen may be directly introduced into the scrubbing liquid, or may be formed in-situ from a halogen source and an oxidizer. Thus, the scrubbing liquid further contains a regenerating agent (also referred to herein as an activating agent or a secondary oxidant), currently preferably hydrogen peroxide. The scrubbing liquid further contains a strong mineral acid, such as sulfuric acid. Without being bound by a particular theory it is believed that upon contact of the gaseous stream comprising a variety of contaminants, as described in further detail below, the contaminants are absorbed in the ionic liquid phase, particularly in presence of some of the water phase, of the scrubbing liquid, wherein they are oxidized by the halogen. The halogen is continuously regenerated by the hydrogen peroxide present in the ionic liquid and/or supplied into the mixture, e.g., into the aqueous phase. The strong mineral acid may accelerate the halogen recycling process in aqueous phase and, as demonstrated in the appended examples, may also unexpectedly shift the partitioning of the halogen towards the ionic liquid phase.

Hydrogen peroxide is incapable of oxidizing some contaminants directly, e.g., nitric oxide, at any commercially viable rate; however, in the scrubbing liquid it is the halogen that oxidizes the contaminants absorbed into the ionic liquid and is concomitantly regenerated in-situ by hydrogen peroxide, forming a catalytic-like cycle. Oxidized sulfur and nitrogen contaminants in form of sulfuric and nitric acid are retained in the scrubbing liquid, and excesses usually readily partitioned into the aqueous phase (e.g. with use of a base), which may be periodically refreshed to remove the accumulated oxidation products and to replenish hydrogen peroxide. Little or no halogen is thus spent in the process, as it does not leave the ionic liquid phase to any appreciable extent, as demonstrated in the appended examples below, and is therefore not exposed to evaporation danger from the aqueous phase, even if the halogen is bromine and the process temperatures are high.

Metallic contaminants may usually be also oxidized by the halogen under the system conditions to their respective oxides. The solids of heavy metal oxides may be readily separated, e.g., by centrifugation or filtration. The oxides may further react with the locally present acids (e.g., sulfuric or nitric) to form a water-soluble salt, which may be extracted into water and removed, e.g., during the recovery treatment. Carbon monoxide may be oxidized into carbon dioxide.

It should be noted that although it is known that halogens, bromine in particular, may catalyze the degradation of hydrogen peroxide (e.g. William C. Bray and Robert S. Livingston, JACS, 1923 45 (5), 1251-1271, DOI: 10.1021/ja01658a021), it has been unexpectedly found that in the water-immiscible ionic liquid the two components co-exist without appreciable loss of function; on the contrary, it has been demonstrated that in absence of hydrogen peroxide bromine becomes readily volatile from the ionic liquid and cannot be used in the process. Similarly, although it has been demonstrated in U.S. Pat. No. 5,266,295 that in an aqueous medium in presence of an acid with pKa below 3 bromide ions can be almost quantitatively converted in an aqueous medium into bromine with aid of hydrogen peroxide, but it has now been found that not only the presence of acid accelerates the recycling process, but also shifts bromine partitioning towards the ionic liquid.

Thus, provided herein a scrubbing liquid useful for decontamination of a gaseous stream from a plurality of contaminants, the scrubbing liquid comprising an aqueous phase and an ionic liquid phase immiscible with said aqueous phase, wherein said ionic liquid phase comprises a water-immiscible ionic liquid, and said aqueous phase comprises water, and further wherein said scrubbing liquid comprises a halogen, a strong acid, and an activating agent. The scrubbing liquid may be wherein said water-immiscible ionic liquid is a halide, sulfate, or nitrate salt, of quaternary phosphonium cation of a general formula R¹ₐR²_{b}R³_{c}R⁴_{d}P(⁺), wherein each of R¹ₐ, R²_{b}, R³_{c} and R⁴_{d} is an organic group containing between 1 and a, 1 and b, 1 and c, and 1 and d carbon atoms, respectively, with a, b, c, and d being cardinal numbers, such that the sum of a+b+c+d is between 10 and 60, wherein said water-immiscible ionic liquid has a melting temperature below 50° C., wherein said ionic liquid has a solubility of the ionic liquid in water at room temperature of less than 5% w/w, and wherein said ionic liquid dissolves no more than 10% w/w of water at room temperature. Preferably, the scrubbing liquid may be wherein the R¹ₐ, R²_{b}, R³_{c} and R⁴_{d} groups are same or different and at least two these groups are C5-C15 alkyl groups, further preferably, wherein the sum of a+b+c+d is between 25 and 40. The scrubbing liquid may also be wherein said water-immiscible ionic liquid is a bromide or nitrate of phosphonium cation. The scrubbing liquid may also be wherein said water-immiscible ionic liquid is tri(hexyl)tetradecyl phosphonium bromide or nitrate. Preferably, the scrubbing liquid may be, wherein said halogen consists essentially of bromine. The scrubbing liquid may also be, wherein said halogen is present in a concentration of 1 to 15 weight percent in said ionic liquid phase, and between 0.01 and 3 weight percent in said aqueous phase. The scrubbing liquid may also be, wherein said activating agent is selected from the group consisting of ozone, chlorine oxide, sodium chlorite, hydrogen peroxide, and a mixture of at least two of the above. The scrubbing liquid may preferably be, wherein said activating agent is hydrogen peroxide. The scrubbing liquid may be, wherein the concentration of said activating agent is between 0.01 and 0.7 weight percent in said ionic liquid phase, and between 0.05 and 2 weight percent in said aqueous phase. The scrubbing liquid may be, wherein said strong acid is a strong mineral acid which comprises sulfuric acid and optionally further comprises an acid selected from the group consisting of sulfuric acid, nitric acid, phosphoric acid, hydrochloric acid, hydrobromic acid, and hydroiodic acid. The scrubbing liquid may also be, wherein said strong acid is present in said scrubbing liquid in a concentration of between 0.01 and 18 weight percent in said ionic liquid phase, and between 7 and 60 weight percent in said aqueous phase. The scrubbing liquid may preferably be, wherein said strong acid comprises sulfuric acid comprises between 0.1 and 9% wt and optionally nitric acid comprises between 0.1 and 8% wt in said ionic liquid phase, and comprises, sulfuric acid comprises between 7 and 50% wt and optionally nitric acid comprises between 0.05 and 10% wt in said aqueous phase. The scrubbing liquid may be, wherein said contaminants are selected from the group consisting of nitrous oxide, nitric oxide, nitric dioxide, sulfur dioxide, sulfur trioxide, carbon monoxide, siloxanes, hydrogen sulfide, and heavy metals. The scrubbing liquid may preferably be, wherein said water-immiscible ionic liquid comprises tri(hexyl)-tetradecyl-phosphonium bromide, said halogen consists essentially of bromine, said strong acid comprises sulfuric acid, and said activating agent comprises hydrogen peroxide, or wherein said water-immiscible ionic liquid comprises tri(hexyl)-tetradecyl-phosphonium nitrate, said halogen consists essentially of bromine, said strong acid comprises sulfuric acid, nitric acid, or mixtures thereof, and said activating agent comprises hydrogen peroxide. The scrubbing liquid may also be, wherein said ionic liquid phase comprises between 80 and 98 weight percent of said scrubbing liquid, and said aqueous phase comprises between 2 and 20 percent of said scrubbing liquid. The scrubbing liquid may particularly be, wherein said liquid comprises between 80 and 98 weight percent of ionic liquid phase, whereof the halogen comprises between 3 and 10% wt, sulfuric acid comprises between 0.1 and 9% wt, optionally nitric acid comprises between 0.1 and 8% wt, and hydrogen peroxide comprises between 0.05 and 0.7% wt, with the balance of the ionic liquid phase being tri(hexyl)-tetradecyl-phosphonium bromide or nitrate, and further the scrubbing liquid comprises between 2 and 20 weight percent of the aqueous phase, whereof the halogen comprises between 0.01 and 3% wt, sulfuric acid comprises between 7 and 50% wt, optionally nitric acid comprises between 0.05 and 10% wt, and hydrogen peroxide comprises between 0.05 and 2% wt, with the balance of the aqueous phase being water.

In a further aspect provided herein a method for decontaminating of a contaminated gaseous stream contaminated with one or more contaminants, by contacting said contaminated gaseous stream with a scrubbing liquid according to any one of preceding claims, to obtain at least partially decontaminated gaseous stream. The method may further be, wherein said contaminated gaseous stream is a natural sour gas, a biogas, or a flue gas resulting from fuel burning or incinerating of combustible substrates.

### BRIEF DESCRIPTION OF THE DRAWINGS

FIG. 1 displays a chart representing nitrogen oxides decontamination according to an embodiment of the invention.

FIG. 2 displays a chart representing nitrogen oxides decontamination according to a further embodiment of the invention.

FIG. 3 displays a chart representing sulfur dioxide decontamination according to an embodiment of the invention.

FIG. 4 displays a chart representing a decontamination yield of flue gas from nitrogen oxides in a pilot-scale assembly according to an embodiment of the invention.

### DETAILED DESCRIPTION

Thus, in a first aspect provided herein a scrubbing liquid useful for decontamination of a gaseous stream from a plurality of contaminants. The scrubbing liquid generally comprises two phases, the ionic liquid phase and aqueous (water) phase. The ionic liquid phase comprises a water-immiscible ionic liquid, and aqueous phase comprises water, and both phases comprise a halogen, a strong acid, and an activating agent (e.g., a secondary oxidizer) to various extents as described below. Without being bound by a particular theory it is believed as follows. A gaseous stream that the disclosed herein single scrubbing liquid is capable of removing the contaminants from, may usually contain the contaminants as described herein. Various contaminants are absorbed into the ionic liquid, either directly or via the aqueous phase, and are oxidized by the halogen in presence of the strong acid. The reduced halogen, i.e., halides, are regenerated by the activating agent, which is a secondary oxidant, usually incapable of oxidizing the contaminants at any appreciable rate. Thus, for example, the “sour” sulfur contaminants that include sulfur dioxide and sulfur trioxide, are usually decontaminated by converting them into sulfuric acid.

Hydrogen sulfide is usually decontaminated by also converting into sulfuric acid. Nitrogen contaminants include nitrogen oxides, e.g. nitrous oxide, nitric oxide, nitric dioxide, and other nitrogen species; these are decontaminated by converting into nitric acid. Minimum or no nitric dioxide is formed from lower nitrogen oxides, e.g., as demonstrated in the appended examples.

Carbon monoxide may be oxidized into carbon dioxide. The same scrubbing liquid may oxidize and remove from the gaseous stream also the heavy metal contaminants. The heavy metals may include mercury, uranium, cadmium, arsenic, lead, selenium, bismuth, tin, copper, or zinc. Siloxanes absorbed within the liquid may be degraded by the solution, or may be also oxidized, ultimately, to their higher oxidation state, e.g., into silicon dioxide, as demonstrated in the examples, which may be separated like the heavy metal decontamination products. The scrubbing liquid may also remove dioxins, at least by direct absorption, and optionally by chemical transformation.

Thus, the scrubbing liquid contains an ionic liquid. The ionic liquid, in its most general form, is an ionic salt with a low melting point, such that it exists in the liquid state at a given temperature, such as the processing temperature, which is preferably below 200° C., e.g., below 150° C., or below 100° C. Generally, the ionic liquids suitable for the present invention are already in liquid state at (i.e., have a melting point of lower than) 50° C., or 30° C., or 25° C., or 15° C., or 10° C., or 5° C., or 0° C., or even below. The ionic salts (liquids) according to the invention preferably contain a nitrogen-based cation, e.g., quaternary ammonium cation, namely, R¹ₐR²_{b}R³_{c}R⁴_{d}N(⁺), or phosphorus-based cation, e.g., quaternary phosphonium cation namely, R¹ₐR²_{b}R³_{c}R⁴_{d}P(⁺) wherein each of R¹ₐ, R²_{b}, R³_{c} and R⁴_{d} is an organic group, preferably an alkyl group, containing between 1 and a, 1 and b, 1 and c, and 1 and d carbon atoms, respectively, with a, b, c, and d being cardinal numbers, such that the sum of (a+b+c+d) is between 10 and 60, preferably between 25 and 40. Preferably, the phosphonium and/or ammonium salts are such that in R¹ₐR²_{b}R³_{c}R⁴_{d}P(⁺) or R¹ₐR²_{b}R³_{c}R⁴_{d}N(⁺), the R¹ₐ, R²_{b}, R³_{c} and R⁴_{d} are the same or different, and at least two, or at least three these groups are C5-C15 (preferably straight) alkyl groups. The counterions in the ionic liquids may be any suitable inorganic ions, preferably halide. It is currently preferred that the halide counterion is chloride or bromide more preferably bromide.

Additionally, and as demonstrated in the appended examples, the halide counterion, e.g., chloride, may also be substituted with nitrate and/or sulfate. These ionic liquids may also be manufactured, e.g., as described in WO 2020/115749, and may further contain super-stoichiometric quantity of anions or their respective acids.

Many ionic liquids are commercially available. Moreover, the ionic liquids may also be synthesized by the methods enumerated in the publication WO 2019/202598.

As described herein, the ionic liquid is generally a water-immiscible compound. The water immiscible ionic liquid is usually an ionic liquid with solubility of the ionic liquid in water at room temperature of less than 10% w/w, preferably less than 8% w/w, e.g., less than 5%, more preferably less than 1.0%, or less than 0.1%, and even down to 0.01% (w/w). Additionally, the water-immiscible ionic liquid may dissolve water at room temperature in concentrations of no more than 10% w/w, e.g. less than 5%, or less than 3%, or even less than 1.5% w/w. The ionic liquid may also be diluted to an appreciable extent with other water-immiscible liquids, e.g., liquid high hydrocarbons, mineral or silicon oils, etc.

One currently preferred ionic liquid is tri(hexyl)tetradecyl phosphonium halide, e.g., bromide, i.e., the salt having a phosphonium cation with three C6 alkyl groups and one C14 alkyl groups (a, b, and c being equal to 6, and d equal to 14, the sum being 32), and the anion being halide, e.g., bromide. An alternative currently preferred ionic liquid is tri-(hexyl),tetradecyl phosphonium nitrate. The amount of these or other ionic liquids as described herein, in the ionic liquid phase of the scrubbing liquid, may usually be between 75 and 98 weight percent of the ionic liquid phase, e.g., in the amount making up to 100% when the other constituents, as described below, are taken in due account.

The scrubbing liquid as described herein is usually a two-phase system comprising the ionic liquid phase and an aqueous phase. The aqueous phase may be formed due to provision of some components into the ionic liquid phase as aqueous solutions. The aqueous phase may also be conveniently used as the extraction medium of the oxidized contaminants from the ionic liquid. Thus, the amount of aqueous phase may vary during various stages of the decontamination process, but will usually be 0 to 50 parts of water to 100 parts of ionic liquid, currently preferably between 2 and 20 weight percent of the weight of the scrubbing liquid. An excess of water phase may be present in the process, but the amount of the aqueous phase preferably used in the process is between 2 and 20 weight percent, e.g., between 7 and 15 weight percent of the weight of the scrubbing liquid. Without being bound by a theory it is believed that excessively high amounts of aqueous phase may interfere with contaminants absorption and therefore may reduce the decontamination efficiency.

The scrubbing liquid also contains a halogen, such as iodine or bromine. The halogen may be selected based on the intended use and the nature of the contaminant in the gaseous stream. For example, when a gaseous stream is not expected to contain nitrogen oxides NOx, the halogen may be iodine. If a versatile scrubbing liquid is needed that is capable of treating also nitrogen oxides, e.g., nitric oxide contamination, the halogen is bromine. Thus, preferably, the halogen is bromine.

The halogens are usually present in the ionic liquid, dissolved therein, in form of molecular halogen, when in use or immediately prior to use. Halogens may be formed in-situ in the ionic liquid from their respective halide precursor anions X⁽⁻⁾, or complexes thereof, just prior to use, or in process of manufacturing or activating of the scrubbing liquid. When halogens are formed in-situ from their precursor anions prior to use, they may be present even in over-oxidized ion forms, e.g. hypohalites XO⁽⁻⁾, such as hypobromite or hypoiodite, in appreciable amounts. Thus, the term “halogen” as used herein encompasses a variety of molecules and complexes, including molecular halogens, hypohalites, polyhalogens and polyhalogen anions, which may be regarded as “active halogens”; and if halogen is produced in-situ, e.g., by activating a precursor liquid to obtain scrubbing liquid prior to use, the term may also encompass halogen precursor anions, e.g., halides. It ought to be borne in mind that halide anions may be present in the ionic liquid as counterions; their amount available for the in-situ conversion into the “halogen”, however, may be limited by the presence of other anions that could liberate halides by ion exchange in the ionic liquid.

The amount of “active halogen” in the scrubbing liquid does not need to be high. Due to the pseudo-catalytic nature of the halogen use in the process, i.e., rapid recovery of halogen with the secondary oxidant (i.e., the activating agent), as described below, the concentration of halogen may be between 0.05 to 7, e.g., from 0.4 and 5 weight percent of the ionic liquid phase. The total amount of halogen, including active halogen species and halogen precursors (halides) may be as high as 25% w/w, particularly when the counter-ion of the ionic liquid is the halide. However, preferably, when the halide is bromide, the amount of halogen in the ionic liquid phase may be between 4 and 15 weight percent of the ionic liquid, particularly when the ionic liquid is bromide, as currently preferably used for decontamination of hydrogen sulfide, as described below. The amount of halogen in the aqueous phase may be similarly between 0.01 and 3 weight percent. Additionally, particularly when the ionic liquid is a nitrate salt, the amount of halogen may be between 3 and 10 weight percent in the ionic liquid, and the amount of halogen in the aqueous phase may be similarly between 0.01 and 3 weight percent. As described below, this composition may be particularly advantageous for nitrogen oxides removal.

Thus, the halogen may be supplied into the scrubbing liquid in any active form, e.g., in its molecular form X₂, or, preferably, may be formed in-situ from the corresponding halide in presence of a secondary oxidizing (i.e., “activating”) agent. The nature of the specific activating agent is usually immaterial to the overall performance of the scrubbing liquid, provided that the activating agent is usually one that is capable of oxidizing the halide into molecular halogen in water or in the ionic liquid. The secondary oxidizing agent may then distribute into the ionic liquid containing the halide anions and oxidize them into the halogen inside the ionic liquid. Alternatively, halide ions may proportionate into the aqueous phase, wherein they may be oxidized by an oxidizer, and then distribute back into the ionic liquid. The exact mechanism is currently believed unknown and considered immaterial, provided the demonstrated capabilities of the scrubbing liquid, e.g., as described in the examples.

As mentioned above, the scrubbing liquid comprises an activating/regenerating agent for the generation or regeneration of active halogen. The terms “regenerating agent”, “activating agent”, “oxidizing agent”, “oxidant”, “secondary oxidant”, and the like, are used herein interchangeably with reference to the species used for regeneration of the active halogen as described herein. One preferable activating agent is hydrogen peroxide. Hydrogen peroxide may be supplied into the scrubbing liquid, e.g., as an aqueous solution. The concentration of hydrogen peroxide in the solution wherein it is supplied may vary according to the needs of the process, and may be as low as 0.05-1%; preferably, however, more concentrated aqueous solutions are used, with the concentration of above about 10% w/w, or above 15% w/w, or above 20% w/w, or even above 25% w/w. Other exemplary suitable, although less preferable, secondary oxidizers include ozone, chlorine oxide, and sodium chlorite, and these may be supplied either directly into the water-immiscible ionic liquid, or into water phase of the scrubbing liquid. More than one secondary oxidizer may be used if needed.

The activating agent may usually be supplied in excess, to maintain the halogen in its active, e.g., molecular form. The amount of oxidizing agent in the scrubbing liquid will be dictated by the process needs but may usually be between 0.01 and 10 percent by weight of the scrubbing liquid. Preferably, the amount of the activating agent in the ionic liquid phase may be between 0.05 and 0.7 weight percent, and in the aqueous phase of the scrubbing liquid may be between 0.05 and 2 weight percent.

Moreover, it has now been unexpectedly found that in presence of hydrogen peroxide, the loss of free bromine due to evaporation is significantly reduced. As demonstrated in the appended examples, even at elevated operation temperatures and high gas flow rate, bromine loss is minimized when hydrogen peroxide is present in the scrubbing liquid, by a factor of at least 30. Thus, preferably, the scrubbing liquid contains bromide/bromine and hydrogen peroxide. Further preferably, the scrubbing liquid contains the bromine and hydrogen peroxide in the amounts as discussed above.

The scrubbing liquid usually further contains an acid, e.g., a strong acid. The strong acid is preferably a strong mineral acid e.g., sulfuric acid or nitric acid. Initially, the strong acid may also comprise phosphoric acid, hydrochloric acid, hydrobromic acid, and hydroiodic acid, however, some of these acids may be washed out from the scrubbing liquid during the process, due to the replacement by the degradation products, specifically, sulfuric and/or nitric acids, depending on the nature of the contaminant. It is currently preferable that the strong acid is sulfuric acid. The scrubbing liquid may further comprise additional strong mineral acid, as described herein. Without being bound by a particular theory it is believed that in presence of the strong acid in the ionic liquid the regeneration of halogen from halide ions proceeds faster and more efficiently, thereby increasing the turnover of the halogen oxidizing pseudo-catalyst. Additionally, as demonstrated by the appended examples, the addition of sulfuric acid (a strong acid) increases the apparent affinity of halogen to the ionic liquid and assists in preserving the free halogen therein, thereby minimizing the risk of halogen losses from the aqueous phase during the process.

The amount of the strong acid in the scrubbing liquid will also be dictated by the process needs but will usually be between 0.1 and 50 percent by weight of the scrubbing liquid, as follows. In the ionic liquid phase, the concentration of the strong acid may usually be between 0.1 and 15% w/w, e.g., between 0.1 and 9 weight percent. For example, when the scrubbing liquid is used for decontaminating of hydrogen sulfide, the strong acid may be sulfuric acid only, and may be present in the ionic liquid phase between 0.1 and 9 weight percent, and in the aqueous phase between 7 and 50 weight percent. When the scrubbing liquid is used for decontaminating of nitrogen oxides as well, the strong acid may be sulfuric acid and nitric acid, and with the sulfuric acid being present in the ionic liquid phase between 0.1 and 9 weight percent and nitric acid being present between 0.1 and 8 weight percent, and in the aqueous phase sulfuric acid being present between 7 and 50 weight percent, and nitric acid being present between 0.05 and 10 weight percent. Thus, preferably, the scrubbing liquid contains bromide/bromine, a strong mineral acid, e.g. sulfuric acid and/or nitric acid, and hydrogen peroxide. Further preferably, the scrubbing liquid comprises these constituents in the amounts as described above.

Thus, provided herein a scrubbing liquid useful for decontamination of a gaseous stream from a variety of contaminants. The scrubbing liquid composition may be modified according to the needs and the anticipated contaminants. For example, for the decontamination of sulfur contaminants and/or heavy metal contaminants but not nitrogen contaminants, the suitable scrubbing liquid may comprise the ionic liquid may be tri(hexyl)-tetradecyl-phosphonium bromide, the halogen that consists essentially of bromine, the strong acid that comprises sulfuric acid, and the activating agent that comprises hydrogen peroxide. Preferably, these constituents are present in amounts as summarized in the table below.

| Ionic liquid phase | | | Aqueous phase | | |
|---|---|---|---|---|---|
| 80-98% wt | | | 2-20% wt | | |
| Br | H₂SO₄ | H₂O₂ | Br | H₂SO₄ | H₂O₂ |
| % wt | % wt | % wt | % wt | % wt | % wt |
| 4-15 | 0.1-9 | 0.05-0.7 | 0.01-3 | 7-50 | 0.05-2 |

For a further example, for the decontamination of a gaseous stream containing nitrogen contaminants, the suitable scrubbing liquid may comprise the ionic liquid may be tri(hexyl)-tetradecyl-phosphonium nitrate, the halogen that consists essentially of bromine, the strong acid that comprises sulfuric acid and nitric acid, and the activating agent that comprises hydrogen peroxide. Preferably, these constituents are present in amounts as summarized in the table below.

| Ionic liquid phase | | | | Aqueous phase | | | |
|---|---|---|---|---|---|---|---|
| 80-98% wt | | | | 2-20% wt | | | |
| Br | H₂SO₄ | HNO₃ | H₂O₂ | Br | H₂SO₄ | HNO₃ | H₂O₂ |
| % wt | % wt | % wt | % wt | % wt | % wt | % wt | % wt |
| 3-10 | 0.1-9 | 0.1-8 | 0.05-0.7 | 0.01-3 | 7-50 | 0.05-10 | 0.05-2 |

Further preferably, the scrubbing liquid comprises tri(hexyl)-tetradecyl-phosphonium bromide or nitrate, the halogen that consists essentially of bromine and/or bromide, the strong acid that comprises sulfuric acid, and/or nitric acid, or mixtures thereof, the activating agent that comprises hydrogen peroxide, and water. Particularly, provided herein a scrubbing liquid comprising between 80 and 98 weight percent of ionic liquid phase, whereof the halogen comprises between 1 and 15% wt, e.g., 3 and 10% wt or 4 to 15% wt, sulfuric acid comprises between 0.1 and 9% wt, optionally nitric acid comprises between 0.1 and 8% wt, and hydrogen peroxide comprises between 0.05 and 0.7% wt, with the balance of the ionic liquid phase being tri(hexyl)-tetradecyl-phosphonium bromide or nitrate, and further the scrubbing liquid comprises between 2 and 20 weight percent of the aqueous phase, whereof the halogen comprises between 0.01 and 3% wt, sulfuric acid comprises between 7 and 50% wt, optionally nitric acid comprises between 0.05 and 10% wt, and hydrogen peroxide comprises between 0.05 and 2% wt, with the balance of the aqueous phase being water.

Generally, the scrubbing liquid is prepared by combining together the components thereof, and allowing them to equilibrate for a period between 1-5 minute(s) and up to 24 hours. The scrubbing liquid may then be ready to use, and will remain usable until an appreciable amount of oxidant is present therein. The shelf-life of the prepared scrubbing liquid will be determined by the specific compositions and the storage conditions. For the manufacturing of the scrubbing liquid, usually, the ionic liquid is provided. The ionic liquid may have the selected counter-ion, or the counter-ion may be substituted, as described, inter alia, in WO2020115749, to obtain an ionic liquid, having nitrate or sulfate as counter-ion. Further components may be added in any suitable sequence, or concomitantly. A halogen, e.g., bromine, may be added directly into the ionic liquid. Alternatively, a halide source, e.g., bromide salt or, preferably, hydrobromic acid, is added into the ionic liquid and mixed until dissolution. If an aqueous solution is used to add components to the ionic liquid, an aqueous phase is thus formed. The two phases may be mixed using any suitable means as known in the art, e.g., mechanical mixers equipped with an impeller of suitable geometry. A strong mineral acid may be then added into the mixture, e.g., concentrated sulfuric acid, and/or concentrated nitric acid. The acid may be added at any suitable stage, e.g., before the halogen source, or after. An activating agent solution, e.g., hydrogen peroxide solution may be added to the mixture, e.g., prior to use, or in advance, and left to equilibrate between 5 minutes to 24 hours, before being ready to use, thus converting the halide into active halogen and increasing proportioning of the active halogen into the ionic liquid. It may be preferable to add the activating agent, i.e., the secondary oxidant as the last component of the scrubbing liquid, to minimize losses due to spontaneous degradation, particularly when the secondary oxidant is hydrogen peroxide. The resultant mixture may be allowed to separate, and desired quantities of both the ionic liquid phase and the aqueous phase may be combined together, to obtain the scrubbing liquid. If the designated use of the scrubbing liquid does not include nitrogen oxides, the addition of the acid(s) may be omitted, yet it is preferred that the acid be used nonetheless.

Thus, as described above, the scrubbing liquid may be supplied in a form of a precursor composition, intended to be converted into an active scrubbing liquid by the addition of some of the components, e.g., the strong acid and/or the activating agent, and/or water. Particularly, the precursor composition may comprise only the ionic-liquid phase. Therefore, provided herein in a further aspect is a scrubbing liquid precursor composition. The precursor composition comprises the water-immiscible ionic liquid as described in greater detail above. The precursor composition further comprises a halogen source, e.g., a halide. The halide may be in form of a salt or in form of hydrohalic acid (HX), e.g., hydrobromic acid, when the halide is bromide. The scrubbing liquid precursor composition may further comprise the strong acid as generally described above. Preferably, the scrubbing liquid precursor composition comprises the water-immiscible ionic liquid, a halide source, and optionally a strong acid.

Preferably, the precursor composition comprises tri(hexyl)-tetradecyl-phosphonium bromide or nitrate, and a bromide source, e.g., salt of bromide, e.g., alkali metal or ammonium salt, or hydrobromic acid. Further preferably, the precursor composition comprises tri(hexyl)-tetradecyl-phosphonium nitrate, hydrobromic acid, and sulfuric acid. The amounts and ratios between the constituents of the precursor compositions are generally similar to these used the scrubbing liquid.

The scrubbing liquid precursor composition is preferably supplied alongside instructions for converting the precursor composition into the scrubbing liquid. The instructions may usually comprise the procedure required for this conversion, including the ratios between the components, the specific required weights of the components, the time intervals required for performing the operations, and the like. The instructions supplied alongside the scrubber liquid precursor composition may be in a printed form, in a form of a label on the contained wherein the precursor composition is supplied, or in a digital form assessable from a local storage or an Internet resource.

In a further aspect provided herein a process for decontaminating of a gaseous stream from contaminants, by contacting the gaseous stream with a scrubbing liquid as generally described herein. All the description pertaining to the scrubbing liquid components and its respective ratios equally apply mutatis mutandis to a method of decontaminating a gaseous stream, generally utilizing the equipment needed to carry out the steps of the method, as known in the art.

The method is generally applicable to a variety of contaminated gaseous streams, as discussed above, and may be particularly beneficial for decontamination of a natural sour gas, a biogas, and/or a flue gas, e.g., resulting from fuel burning or incinerating of combustible substrates. The method may further comprise quenching or heating the gaseous stream to a temperature of between 30 to 75° C., preferably between 6° and 75° C. prior to the contacting with scrubbing liquid, e.g., about 35° C. or 65° C. The quenching may be performed as known in the art, e.g., by a heat exchanger. The method may also comprise pre-treating the gaseous stream with catalytic or non-catalytic reduction systems e.g., to reduce the quantity of nitrogen oxide contaminants, e.g., with ammonia, as known in the art. Additionally, the gaseous stream may be pre-treated to remove particulate matters, for example by a fabric filter.

The contacting may usually be performed by spraying the scrubbing liquid from a top portion of a vertical contactor assembly, such that the contaminated gaseous stream is conducted from a bottom portion upwards of the vertical contactor assembly. The contacting time duration according to the methods may be generally between 0.5 and 10 seconds; naturally, for the process efficiency, lower contacting times are preferred, such as, e.g., 2 to 5 seconds. The contacting may be performed on a packed contacting media, or in a liquid column wherein the gaseous stream is supplied. Additionally, the gas may be supplied into the reservoir of the scrubbing liquid formed at the lowest portion of the vertical contactor assembly, thereby combining the contacting by bubbling through a liquid column and the contacting on the contacting media. When the contacting media are used, they may be characterized by a surface area of between 100 and 350 square meters per cubic meter of said contacting media, and void fraction of above 90%. The method may further comprise collecting a portion of the scrubbing liquid that has undergone said contacting, e.g., has flown down the contacting media, and recirculating this portion for further contacting with a new portion of the contaminated gaseous stream. The contacting may usually comprise applying between 1 and 2 liters of the scrubbing liquid per one cubic meter of the contaminated gaseous stream per hour. The method may further comprise continuously or intermittently combining fresh portions of the activating agent with the ionic liquid or the gaseous stream. The activating agent may be supplied into the ionic liquid reservoir, particularly when the gaseous stream is bubbled through it, e.g., to facilitate mixing. The activating agent may also be mixed with the recirculating stream. The method may also further comprise removing continuously or periodically a portion of the scrubbing liquid, separating oxidation products of the contaminants, optionally correcting the composition of the scrubbing liquid by adding further amounts of the halogen, the strong acid, and/or the activating agent, to obtain regenerated scrubbing liquid, and returning the regenerated scrubbing liquid into the vertical contactor scrubber.

A suitable apparatus for carrying out the gas purification on an industrial scale is a gas-liquid contactor, which may generally be in the form of an absorption tower (for example, 10 to 30 m high tower with diameter of about 1-15 m). The incoming flue gas stream enters the tower through an inlet, usually located at the bottom part of the tower, e.g., in the lower portion of the lateral surface of the tower, and is allowed to flow upward, exiting the tower through an outlet located at the top part of the tower. A suitable blower which operates at conventional throughputs, say, from 1,000 to 2,000,000 m³/hour may be used to push the flue gas, and from 40 to 10,000 m³/hour may be used to push the biogas. A typical flue gas may contain from about 100 to 4000 ppm sulfur dioxide and from about 50 to 700 ppm nitrogen oxides, thus the flow rates of these contaminants through the tower are expected to vary between 0.02 and 1000 kg/h. Optionally, the flue gas may be passed through a heat exchanger before it enters the tower, to reduce its temperature to less than 150° C., e.g., to about 40-100° C. The biogas may also contain between 100 to 5,000 ppm of hydrogen sulfide, and between 0.1 to 100 mg/m³ of siloxanes.

The tower may optionally be packed with a suitable filling, whereon the scrubbing liquid stream that is supplied through an inlet located at the top of the tower. The filling may usually be a random packing with void fraction of above 90%, preferably above 95%. The filling may also be characterized by the surface-area to volume ratio, which may usually be between 100 to 350 square meters per cubic meter of the filling, preferably about 200 m²/m³. The scrubbing liquid is distributed, throughout in the internal space of the tower, e.g. by the aid of one or more spray heads or an array of nozzles mounted within the tower. The upwardly moving gas is exposed to the liquid stream that flows in the opposite direction, resulting in capturing the contaminants and oxidizing them in the scrubbing liquid. The recirculation rate may be selected according to the gas flow rate, to maintain the scrubbing liquid to gas ratio of between 1:1 and 1:2 liters per cubic meter, in a given time interval. Preferably, the liquid to gas ratio is between 1:1.4 and 1:1.6, e.g., about 1:1.5. The liquid retention time in the scrubber may therefore be affected by the process parameters, e.g., the recirculation rate, the gas flow, the type and amount of packing, and other parameters as known in the art.

Thus, the scrubbing liquid may be collected at the bottom of the tower and recirculated to the top of the scrubber for continuous process. Alternatively, the scrubbing liquid that has flown down the tower may be removed from the tower into an operation tank, and recirculated from the tank to the top of the tower. The scrubbing liquid may be allowed to separate to ionic liquid phase and to aqueous phase, either at the bottom of the tower or at a designated vessel. At least a portion of the aqueous phase may be removed and replaced with fresh aqueous medium, e.g., by the supply of aqueous activating agent.

Thus generally, a portion of the scrubbing liquid may be sometimes, e.g., periodically or continuously, removed from the process, e.g., by splitting the recirculating stream of the gas-liquid contactor. The purpose of this partial removal of the scrubbing liquid is to remove a part of the aqueous phase which accumulates the oxidized products of the gaseous stream contaminants, and to adjust its composition, or, conversely, to compensate for water evaporation. The ionic liquid of the partially removed scrubbing liquid may also be regenerated, e.g., to remove the absorbed contaminants' oxidation products; the decontaminated ionic liquid may then be returned into the scrubber, or used to prepare a fresh portion of the scrubbing liquid. The removed part of the scrubbing liquid may be allowed to separate into two phases, or may be forced-separated, e.g., by centrifugation. If the concentration of the oxidizing agent or the strong acid in the ionic liquid phase falls below a predetermined threshold value, further oxidizing agent and/or the strong acid may be added, e.g., into the aqueous phase.

All publications mentioned in the present disclosure are incorporated herein by reference. The preferred embodiments and the drawings demonstrating some of the embodiments of the present invention are provided to better understand the present invention, which however does not limit the invention in any respect. Many variants and equivalents may be readily envisaged by the skilled artisan; the invention therefore encompasses all of these variations and equivalents. The terms referring to system parts, e.g., denoted as “scrubber”, “pump”, and the like, comprise both a single unit of the equipment, as well as several pieces of such equipment connected consecutively or in parallel. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C). It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

### Examples

### Materials and Methods

Mercury concentration was determined using HG-MONITOR 3000 by Seefelder Messtechnik, Germany. Hydrogen sulfide (H2S) concentration was determined using a 7HH CiTiceL analyzer from City Technology Ltd, gas analyzer manufactured by Emproco ltd Israel. Nitrogen oxides (NOx) concentration was determined using T2NFF and T3NDH CiTiceL analyzer from City Technology Ltd, gas analyzer manufactured by Emproco ltd Israel. Alternatively, the gases were analyzed using ABB analytic system, comprising SCC-S Sample gas feed unit, SCC-K NO₂/NO converter, and URAS 26-NO-SO₂ and O₂ analyzer, all by ABB Germany.

Trihexyl(tetradecyl)phosphonium chloride (P66614*Cl, CYPHOS® IL 101) (hereinbelow: “IL*Cl”) and trihexyl(tetradecyl)phosphonium bromide (P66614*Br, CYPHOS® IL 102) was purchased from Strems chemicals (hereinbelow: “IL*Br”). Hydrobromic acid 48% solution manufactured by Alfa Aeasar was purchased from Holand Moran, Israel. Hydrogen peroxide 30% solution and sulfuric acid 96% solution were purchased from Sahar Chemicals. Further suppliers and materials were as follows:

| | Chemical | | % in | |
|---|---|---|---|---|
| Chemical Name | formula | CAS num | solution | Supplier |
| CYPHOS ® IL 101 | C₃₈H₆₈ClP | 258864-54-9 | 97.7 | CYTEC |
| Hydrobromic acid | HBr | 231-639-5 | 48 | Penta Chemicals |
| | | | | Czechia |
| Sulfuric acid | H₂SO₄ | 231-639-5 | 96 | ChemLogistic |
| Nitric acid | HNO₃ | 7697-37-2 | 69-70 | |
| Hydrogen peroxide | H2O2 | 7722-84-1 | 35 | Deltachem |

### Example 1—Absorption of Hydrogen Sulfide from Biogas Stream by IL*Br with Bromine

Tri(hexyl)tetradecyl phosphonium bromide (CYPHOS® IL 102), 134 gr, and 5.17 gr of 48% solution of HBr were mixed at 50° C. for 5 minutes, then 17 gr of 30% solution of hydrogen peroxide was added. The mixture was stirred at 50° C. for another 5 minutes. After phase separation two phases were observed: clear orange aqueous phase and clear red organic phase. Thereafter, 53 gr of 96% solution of sulfuric acid were added. The mixture was further stirred at 50° C. for 5 minutes. After phase separation two phases were observed: clear uncolored aqueous phase and clear red-orange organic phase. Solution composition:

| IL*Br phase | | aqueous phase | |
|---|---|---|---|
| H₂SO₄ | Br₂ | H₂SO₄ | H₂O₂ |
| wt % | % | wt % | wt % |
| 11.4 | 3.32 | 48.0 | 0.137 |

The gas trap used was a cylindrical gas column filled with scrubbing liquid, described below. The biogas obtained from home waste digester was directed into the bubbler through a 8 mm pipe near the bottom of the bottle, and was passed through the scrubbing liquid. The treated gas stream was collected from the top of the column and analyzed for hydrogen sulfide content. The process was carried out at room temperature.

Experimental setup contained a biogas supply, followed by experimental gas trap. The gas trap was loaded with 140 gr of organic phase and 30 gr of aqueous phase. The biogas composition measurement results are presented in the table below.

| CH₄ | CO₂ | O₂ | H₂S |
|---|---|---|---|
| % | % | % | ppm |
| 59.2 | 38.92 | 0.08 | 1053 |

The gas flow rate was set to 2.5 LPM and kept constant. The gas was passed through the scrubber. The H2S concentration in the outlet treated gas after the gas treatment was measured after 1, 8, 11 and 15 minutes. After the elapsed time of 11 minutes, total amount of 0.7 gr H₂O₂ (30% solution) was added. The H2S concentration in the inlet gas was above 1053 ppm, and the outlet gas concentrations during the experiment are presented in table below.

| Time (min) | 1 | 8 | 11 | 15 |
|---|---|---|---|---|
| H₂S [C] (ppm) | 15 | 12 | 11 | 9 |

It can be seen from the results that the treated gas underwent three orders of magnitude reduction in hydrogen sulfide content.

### Example 2—Absorption of Mercury from Synthetic Stream by IL*Br with Bromine

The scrubbing liquid was prepared as described above for P66614*Br, without the addition of sulfuric acid. Trihexyl(tetradecyl)phosphonium bromide was used in an amount of 8.95 gr, hydrobromic acid solution -0.547 gr, and hydrogen peroxide was used in a quantity of 0.558 gr. After mixing the components for 5 minutes at 50° C. and phase separation, two phases were obtained: clear orange aqueous phase and clear red ionic liquid phase. The ionic liquid phase contained 1.2% of bromine (as Br₂).

The gas trap was loaded with 7 gr of ionic liquid organic phase only. The gas flow was set of 0.8 LPM and kept constant. The gas temperature was 22° C., and the scrubbing liquid temperature was kept at 35° C. in a water bath.

The synthetic gas (air passed through permeation tube containing elemental mercury) entered the bubbler near the bottom and was passed through the scrubbing liquid. The treated gas stream was collected through the top of the trap and analyzed for mercury. The results are demonstrated in the table below.

| Time, (min) | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Hg [C], μg/m³ | 115 | 131 | 136 | 5 | 0.5 | 0.5 | 0.5 | 0.5 | 0.5 | 0.5 | 0.5 | 0.5 | 114 | 133 | 135 |

| | | | |
|---|---|---|---|
| Gas | Feed | Treated | Feed |

It can be seen from the results that the feed gas concentrations remained stable, whereas the treated gas has consistently had very low concentration of mercury. Mercury has been trapped even without the use of the strong acid or the aqueous phase.

### Example 3—Absorption of Nitrogen Oxide from Industrial Combustion Flue Gas by IL*Br with Bromine

Experimental setup contained a combustion flue gas source connected to the gas trap. The combustion flue gas was obtained from coal-fired boiler in Rutenberg Power Station after SCR and WFGD. In brief: SCR: Selective Catalyst Reduction (SCR)—systems remove nitric oxide from exhaust flue gases, reduction reactions to take place in an oxidizing atmosphere. It is called “selective” because it reduces levels of NOx using ammonia as a reductant within a catalyst system. FGD: Flue Gas Desulfurization (FGD) systems remove sulfur dioxide from exhaust flue gases of power plants generated by fossil fuel. This process uses an absorbent (limestone) and produces stable and valuable by-products (gypsum).

The gas trap was loaded with 70 gr of scrubbing liquid prepared according to the example 1. Solution composition was:

| Ionic liquid phase | | Aqueous phase | |
|---|---|---|---|
| H₂SO₄ | Br₂ | H₂SO₄ | H₂O₂ |
| wt % | % | wt % | wt % |
| 11.2 | 3.1 | 49.5 | 0.21 |

The flue gas flow was set of 0.7 LPM and kept constant, the flue gas temperature was 45° C.

### Inlet Flue Gas Composition is Summarized Below:

| NO | SO₂ | O₂ |
|---|---|---|
| ppm | ppm | % |
| 45 | 25-28 | 7.8 |

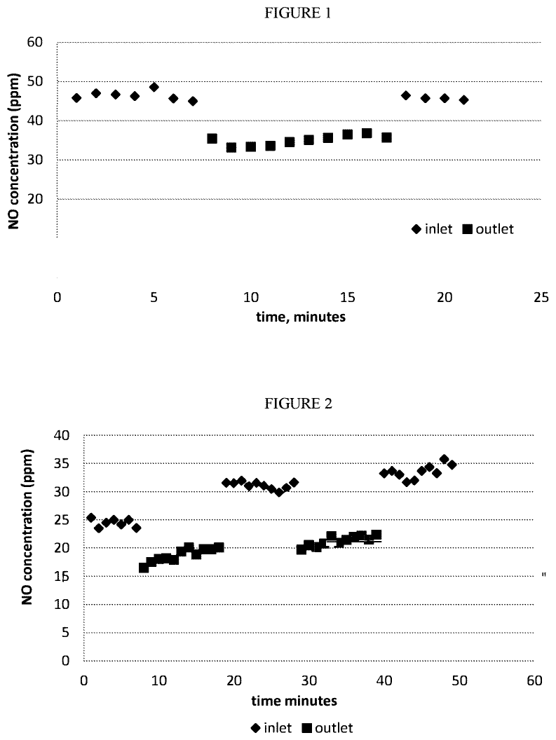

The nitric oxide (NO) concentrations were measured over 21 minutes, alternatingly, at the inlet and at the outlet. The results are presented in FIG. 1. In the figure, the concentrations of nitrous oxide (designated at the vertical axis caption as “NO concentration (ppm)”) is demonstrated versus the time elapsed from the beginning of the experiment, designated at the caption of the horizontal axis as “time, minutes”. The concentration at inlet is shown as designated on the graph and in the legend, filled rhombs and title “inlet”, and the concentration at the outlet is shown as designated on the graph and in the legend, filled squares and title “outlet”.

It can be seen that a significant reduction in NO content is achieved using the scrubbing liquid as described above. It is noteworthy that no nitric dioxide was detected in the outlet gas stream, indicating complete conversion of nitrogen oxides into nitric acid.

### Example 4—Absorption of Nitrogen Oxide and Sulfur Dioxide from Industrial Combustion Flue Gas by IL*N03 with Bromine

Experimental setup was as described for the Example 3 above. The scrubbing liquid was prepared as follows.

Tri(hexyl)tetradecyl phosphonium chloride, 150 gr, and potassium nitrate 10% solution, 170 gr, were mixed at 98° C. for 5 minutes, then left 20 minutes for phase separation. The clear aqueous phase (the lower phase) was discarded, and fresh aliquot of 170 gr potassium nitrate solution was added. The mixture was likewise stirred at 98° C. for 5 minutes, allowed to separate, and the clear aqueous phase was discarded. After another washing with potassium nitrate solution, the ionic liquid phase was collected.

To ensure that chloride counter-ions were fully displaced by nitrate, the ionic liquid was analyzed for the presence chloride (Cl⁻) ions, by standard silver nitrate titration (0.05 N with 5% K₂CrO₄ indictor). The obtained concentration in the resultant ionic liquid was 0.02 mol/kg, indicating that 99% of the Cl ions were replaced by NO₃. The nitrate ionic liquid that was obtained was named “IL*NO₃”.

Thereafter, 130 gr of IL*NO₃ were mixed with 17 gr of 70% solution of nitric acid at 50° C. for 5 minutes. After phase separation two phases were obtained. The light phase contained 7.4% HNO₃ solution.

To the resultant mixture (147 gr), 14.7 gr of HBr (48% solution) were added and mixed at 50° C. for 5 minutes, followed by 19.8 gr of hydrogen peroxide 30% solution. After phase separation two phases were obtained: clear orange aqueous phase and clear red ionic liquid phase. Into this mixture, 42 gr of sulfuric acid (96% solution) was added. The mixture was stirred at 60° C. for 5 minutes. After phase separation two phases the aqueous phase was clear and colorless, and the ionic liquid phase was colored in red-orange.

### Solution Compositions:

| Ionic liquid phase | | | Aqueous phase | | |
|---|---|---|---|---|---|
| Br₂ | H₂SO₄ | HNO₃ | H₂O₂ | H₂SO₄ | HNO₃ |
| wt % | wt % | Wt % | Wt % | wt % | Wt % |
| 1.43 | 38.9 | 0.4 | 0.25 | 3.12 | 8.3 |

Inlet flue gas composition for this experiment was as described below.

| NO | SO₂ | O₂ |
|---|---|---|
| ppm | ppm | % |
| 25-37 | 28-40 | 8.1 |

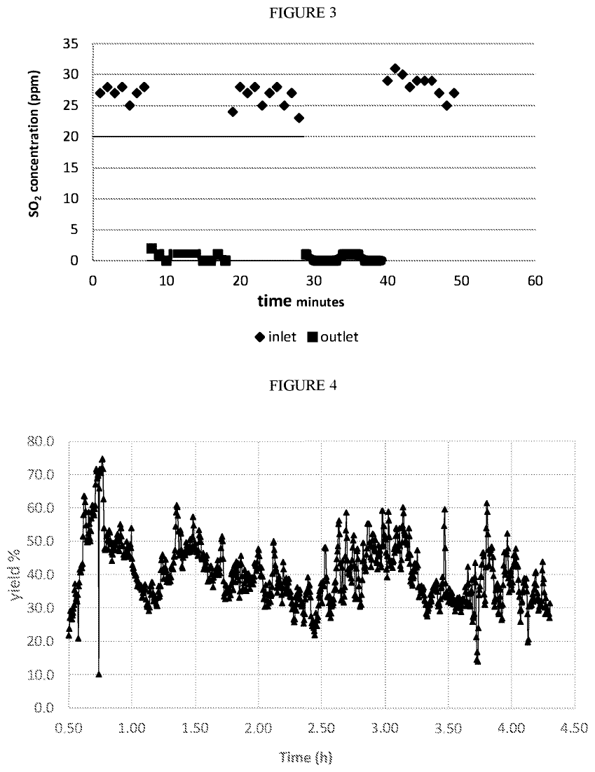

The outlet gas was monitored for the duration of the experiment, and the results indicate that NOx is oxidized and absorbed in the absorption liquid; the results are also shown in the FIGS. 2 and 3. In the figures, the concentrations of nitrous oxide (designated at the vertical axis caption as “NO concentration (ppm)”) in FIG. 2 or sulfur dioxide (designated at the vertical axis caption as “SO₂ concentration (ppm)”) in FIG. 3, is demonstrated versus the time elapsed from the beginning of the experiment, designated at the caption of the horizontal axis as “time, minutes”. The concentration at inlet is shown as designated on the graph and in the legend, filled rhombs and title “inlet”, and the concentration at the outlet is shown as designated on the graph and in the legend, filled squares and title “outlet”.

It can be readily seen from the figures that the concentration of the contaminants in the feed stream has been very significantly reduced, and in case of sulfur dioxide, the feed stream was almost quantitatively decontaminated. It is noteworthy that no nitric dioxide was detected in the outlet gas stream, indicating complete conversion of nitrogen oxides into nitric acid.

### Example 5—Absorption of Nitrogen Oxides from Forklift Outlet Gas by IL*N03 with Bromine, as Function of Contact Time

Experimental setup used was as described for the Example 4.

IL-*NO₃ was prepared as described in the Example 4. Thereafter, 140 gr of IL-NO₃ were mixed at 50° C. for 5 minutes, with 25 gr of HNO₃ 70% solution. After phase separation two phases were obtained. The light phase contained 10.2% of nitric acid.

From the resultant mixture, 145 gr of organic phase were mixed with 21.47 gr of HBr (48% solution) at 50° C. for 5 minutes, followed by 29.7 gr of hydrogen peroxide 30% solution. After phase separation two phases were obtained: clear orange aqueous phase and clear red ionic liquid phase. After discarding the aqueous phase, 38 gr of sulfuric acid (96% solution) was added. The mixture was stirred at 60° C. for 5 minutes. After phase separation two phases the aqueous phase was clear and colorless, and the ionic liquid phase was colored in red-orange. After discarding the aqueous phase, the ionic liquid was washed twice with 15 gr aliquots of sulfuric acid 35% solution, for 5 minutes at 50° C. The last aqueous phase was retained.

The resultant scrubbing liquid composition was as described below.

| Ionic liquid phase | | | Aqueous phase | | | |
|---|---|---|---|---|---|---|
| Br₂ | H₂SO₄ | HNO₃* | H₂SO₄ | HBr | H₂O₂ | HNO₃ |
| % | wt % | wt % | wt % | Wt % | wt % | wt % |
| 1.8 | 0.93 | 5.53 | 29.8 | 0.07 | 0.17 | 1.02 |

*calculated

A countercurrent 50×500 mm packed polypropylene column was used to simulate a wet scrubber system. The countercurrent column contained a stainless steel VFF Pall-Ring packing to promote mass transfer and intimate contact between the gas stream and scrubbing liquid. A peristaltic pump was used to pump the scrubbing liquid cyclically. The flow rate of the scrubbing solution was−0.1 L/min; the solution was drawn from the bottom of the column and fed onto the top. The scrubber was connected to Forklift (X40M series model FD-40T-M3G(2)3 by Maximal forklift, Fuyang, Hangzhou, China) outlet gas through flow meter. The flow ret was set to 16-5 lit/min, as described in the table below. The inlet flue gas contained 60 ppm NO and 9 ppm NO₂.

The NO concentrations in the outlet of the scrubber at varying gas flow rates presented in the table below.

| Gas flow rate lit/min | 16 | 12 | 12 | 12 | 8 | 5 | 13 | 16 | 17 | 13 | 8 |
|---|---|---|---|---|---|---|---|---|---|---|---|
| NO (ppm) | 24 | 30 | 36 | 36 | 24 | 12 | 36 | 48 | 48 | 36 | 12 |

### Example 6—Influence of Hydrogen Peroxide Addition on Bromine Evaporation

Trihexyl(tetradecyl)phosphonium bromide (CYPHOS® IL 102), 145 gr, and 3.9 gr of HBr (48% solution), were mixed at 50° C. for 5 minutes, then 17 gr of hydrogen peroxide (30% solution) was added. The mixture was stirred at 50° C. for another 5 minutes. After phase separation two phases were observed: clear orange aqueous phase and clear red organic phase. Thereafter, 35 gr of sulfuric acid (96% solution) were added. The mixture was further stirred at 50° C. for 5 minutes. After phase separation two phases were observed: clear uncolored aqueous phase and clear red-orange organic phase(IL*Br). Solution composition:

| Aqueous phase | | Ionic liquid phase |
|---|---|---|
| H₂SO₄ | H₂O₂ | Br₂ |
| wt % | Wt % | % |
| 39.3 | 0.45 | 2.1 |

The gas trap was loaded with 70 gr of ionic liquid organic phase (IL*Br) and 10 gr of aqueous phase. The air flow was set of 0.8 LPM and kept constant. The scrubbing liquid temperature was kept at the desired temperature in a water bath.

Outlet bromine concentration in equilibrium with scrubber solution that contained 0.45% H₂O₂ in the aqueous phase was measured at two temperature points. The results are as follows: at 35° C. the outlet concentration of bromine was 9 μg per cubic meter, whereas at 45° C. the outlet bromine concentration was 6 μg per m3.

The scrubber solution was heated to 90° C. for 45 minutes, to decompose hydrogen peroxide.

The solution composition after heating is presented in table below:

| Aqueous phase | | Ionic liquid phase |
|---|---|---|
| H₂SO₄ | H₂O₂ | Br₂ |
| wt % | wt % | % |
| 40.2 | 0 | 2.1 |

Outlet bromine concentration in equilibrium with scrubber solution that contained no hydrogen peroxide in the aqueous phase was measured at three temperature points. The results are as follows: at 35° C. the outlet concentration of bromine was 517 μg per m³ cubic meter, at 45° C. the outlet bromine concentration was 620 μg per m³, and at 50° C. the concentration was 1757 μg/m³.

Into the same system, 0.87 gr of hydrogen peroxide 30% solution was added. The solution composition after hydrogen peroxide is presented in table below.

| Aqueous phase | | Light phase |
|---|---|---|
| H₂SO₄ | H₂O₂ | Br₂ |
| wt % | Wt % | % |
| 38.9 | 0.47 | 2.1 |

Outlet bromine concentration in the outlet gas was immediately measures at three temperature points. The results are as follows: at 30° C. the outlet concentration of bromine was 22 μg per m³, at 35° C. the outlet bromine concentration was 17 mg per m³, and at 50° C. the concentration was 53 μg/m³.

It can be unequivocally seen that in presence of hydrogen peroxide in the system the volatile loss of bromine is reduced by at least a factor of about 30.

### Example 7—Absorption of Nitrogen Oxide (NOx) from Waste Incinerator Combustion Flue Gas by IL*N03 with Bromine at Large Scale Pilot

Flue gas from boiler operated on municipal waste incinerator, has been supplied by bypass connectors attached to the main flue exhaust. The flue gas has been pre-treated by selective non-catalyst reduction system. The system removed a portion of nitric oxide from exhaust flue gases by a known ammonium injection, passed the gaseous stream through a fabric filter to remove particular matter, and other specific filters according to the practice of the site. The flue gas was passed through heat exchanger for gas cooling before entering the scrubber.

The scrubber contained three functional parts. A vertical column of 3900 cm in height and 1000 mm in diameter was used. The topmost part was used for evacuating the treated flue gas and for spraying the scrubber liquid. The central portion was used for contacting the flue gas with the scrubber liquid. The bottom portion served as a reservoir for the scrubber liquid and above it an inlet for the untreated flue gas was placed. This formed the gas-liquid counter-current flow in the scrubber. The bottom portion contained a conic low part for separation of the aqueous phase, and an outlet placed above the level of phase separation, for recirculation of the scrubbing liquid.

The flue gas was blown through the scrubber from the bottom upwards through the packed-bed section in the middle part of the scrubber, comprising Hiflow™ ring type 15-7 polypropylene packing [RVT, Germany]. The scrubbing liquid has been supplied from the top onto the contact bed. The scrubber's diameter has been designed for 0.7-1.5 m/s gas velocity, and the packed bed size permitted 3-5 seconds retention time. Further parameters are presented below.

The scrubbing liquid was accumulated at the bottom and the ionic liquid phase with unseparated water phase was recycled to the top to be sprayed on top of the packed bed. The flue gas flow was kept within the limits of between 0.7-0.9 m/s, yielding between 2,000 and 2,500 cubic meters per hour. The scrubbing liquid has been recirculated at a rate of between 3 and 4 cubic meters per hour. The flow rate of the flue gas and the recirculation rate of the scrubbing liquid were controlled using controllable blower and pump, respectively. The temperature was measured at inlet and outlet, was constant throughout the measurements, at between 64 and 66° C.

The wet scrubber was loaded with 500 kg of scrubbing liquid, which was prepared as follows: tri(hexyl)tetradecyl phosphonium chloride, 150 kg, and potassium nitrate 10% solution, 170 kg, were mixed at 65° C. for 15 minutes, then left 20 minutes for phase separation. The clear aqueous phase (the lower phase) was discarded, and fresh aliquot of 170 kg potassium nitrate solution was added. The mixture was likewise stirred at 98° C. for 15 minutes, allowed to separate, and the clear aqueous phase was discarded. After another washing with potassium nitrate solution, the ionic liquid phase was collected. To ensure that chloride counter-ions were fully displaced by nitrate, the ionic liquid was analyzed for the presence chloride (Cl⁻) ions, by standard silver nitrate titration (0.05 N with 5% K₂CrO₄ indictor). The obtained concentration in the resultant ionic liquid was 0.02 mol/kg, indicating that 99% of the Cl ions were replaced by NO3. The nitrate ionic liquid that was obtained was named “IL*NO3”. Thereafter, 130 kg of IL*NO3 were mixed with 17 kg of 70% solution of nitric acid at 50° C. for 15 minutes. After phase separation two phases were obtained. The light phase contained 7.4% HNO₃ solution.

To the resultant mixture (147 kg), 14.7 kg of HBr (48% solution) were added and mixed at 50° C. for 5 minutes, followed by 6.6 kg of hydrogen peroxide 30% solution. After phase separation two phases were obtained: clear aqueous phase and clear red ionic liquid phase. Into this mixture, 110 kg of sulfuric acid (35% solution) was added. The mixture was stirred at 60° C. for 15 minutes. After phase separation two phases the aqueous phase was clear and colorless, and the ionic liquid phase was colored in red-orange.

The resultant scrubbing liquid composition was as described in the table below.

| Aqueous phase | Ionic liquid phase | | |
|---|---|---|---|
| H₂SO₄ | Br₂ | H₂SO₄ | HNO₃ |
| wt % | wt % | wt % | Wt % |
| 23 | 3.1 | 0.94 | 4.3 |

The hydrogen peroxide solution was injected directly into the scrubbing liquid circulation, as a function of NO concentration at outlet gas and controlled automatically. The average injection rate was 0.75 Kg/hr of 35% w/v of hydrogen peroxide solution.

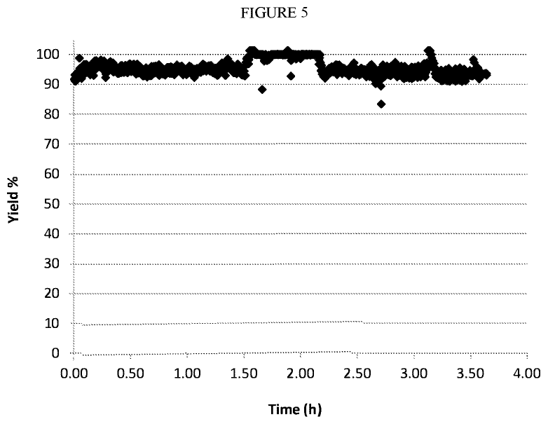

The test run for 4.5 hours. The system was allowed to equilibrate for the first 30 minutes. The outlet NOx concentration was measured continuously during the trial before and after the scrubber. The results are presented in the FIG. 4. In the Figure, the efficiency of NOx removal, calculated as ((NO in -NO out)/NO in)*100), is presented at the vertical axis and designated by a caption “yield %”, versus a horizontal axis presenting the time elapsed and designated by a caption “Time (h)”. As it can be seen from the graph, the average process yield (±standard deviation of mean) was 41±9.3.

### Example 8—Absorption of Nitrogen Dioxide (NO2) and Sulfur Dioxide (SO2) from Waste Incinerator Combustion Flue Gas by IL*N03 with Bromine at Large Scale Pilot

A further run was conducted with a system as in the Example 7. A reduced flue gas flow rate of between 700 and 800 cubic meters per hour was used, providing gas residence time of about 2 seconds. Ozone was injected into the flue gas stream to facilitate oxidation of NOx to nitric dioxide using static gas mixer. Ozone was supplied up to 90 g/h using ozone generator (DISA Generator Ozon SWO 100) as 10% ozone in neat oxygen with 02 flow of 1.5 m³/h. The scrubbing liquid was prepared as in the Example 7.

The composition of the gas stream at inlets and outlets of the scrubber are summarized below.

| | | C [NO₂] | C [SO₂] |
|---|---|---|---|
| # | | mg/m³ | mg/m³ |
| 1 | Inlet | 63 ± 10.9 | 133 ± 20 |
| | Outlet | 17 ± 10.7 | 2 ± 0.8 |
| 2 | Inlet | 54.9 ± 7.09 | 274 ± 118 |
| | Outlet | 7.7 ± 8.19 | 2 ± 0.7 |
| 3 | Inlet | 87.3 ± 10.7 | 203 ± 20 |
| | Outlet | 31 ± 5.03 | 2 ± 1 |

It can be seen that under the tested conditions the scrubbing liquid has almost quantitatively decontaminated sulfur dioxide in the flue gas and has caused between about three-fold to eight-fold reduction in the nitric dioxide concentrations. The total decontamination yield of nitric dioxide was about 72% (range 57.8-85.9%).

### Example 9—Absorption of Siloxane from Biogas Stream from Landfill by IL*Br with Bromine

The experiment setup was as in the Example 1. The scrubbing liquid of the following composition was used.

| IL*Br phase | | aqueous phase | |
|---|---|---|---|
| H₂SO₄ | Br₂ | H₂SO₄ | H₂O₂ |
| wt % | % | wt % | wt % |
| 6.1 | 2.6 | 26.4 | 0.12 |

Trihexyl(tetradecyl)phosphonium bromide (CYPHOS® IL 102), 134 gr, and 5.17 gr of 48% solution of HBr were mixed at 50° C. for 5 minutes, then 17 gr of 30% solution of hydrogen peroxide was added. The mixture was stirred at 50° C. for another 5 minutes. After phase separation two phases were observed: clear orange aqueous phase and clear red organic phase. Thereafter, 30 gr of 96% solution of sulfuric acid were added. The mixture was further stirred at 50° C. for 5 minutes. After phase separation two phases were observed: clear uncolored aqueous phase and clear red-orange organic phase.

The biogas obtained from landfill was directed into the bubbler through a 8-mm pipe near the bottom of the bottle, and was passed through the scrubbing liquid. The gas flow rate was set to 1 LPM and kept constant. The process was carried out at room temperature. The treated gas stream was collected from the top of the column in a 5-liter Tedlar Bag to contain the gaseous specimens prior to analysis at an external service provider with GC-MS. Additionally, samples from the aqueous phase of the scrubbing liquid were extracted periodically during the test and analyzed for the presence of silicon. The biogas initial composition and the outlet (obtained after 40 minutes of test run) are presented in the table below.

| | | | | | | Total |
|---|---|---|---|---|---|---|
| | CH₄ | CO₂ | O₂ | N₂ | H₂S | Si |
| | % | % | % | % | ppm | mg/m³ |
| Inlet | 45 | 35 | 2.5 | 17 | 60 | 22 |
| Outlet | 43 | 31 | 5.5 | 20 | >1 | 0.5 |

It can be seen from the results that the treated gas displayed three orders of magnitude reduction in total siloxane and hydrogen sulfide content.

The absorption test was continued for additional 7 hours in order to examine the Si accumulation in the aqueous phase. After 1 hour the aqueous phase contained 190 mg silicon dioxide per kg, after 5.5 hours -213 mg/kg, and after 7 hours -318 mg/kg. The scrubbing liquid was kept closed after the experiment for additional 18 hours, and the aqueous phase was sampled again. The concentration of silicon dioxide increased to 470 mg/kg, probably due to ongoing hydrolysis and partitioning from the ionic liquid into aqueous phase.

### Example 10—Absorption of Hydrogen Sulfide (H2S) from Wastewater Treatment Gas by IL*Br with bromine at large scale pilot

Biogas from wastewater treatment has been supplied by bypass connectors attached to the main pipeline (300 m³/h biogas). The biogas has been pre-treated by water trap to remove wastewater droplets from the gases. The biogas was saturated with water vapors, contained 63% of methane and 37% of carbon dioxide, with between 1300 and 1700 ppm of hydrogen sulfide.

The scrubber used was similar to what was used in the Example 7. A vertical column of 2200 cm in height and 150 mm in diameter was used as the scrubber. The topmost part was used for evacuating the treated biogas and for spraying the scrubber liquid. The central portion was used for contacting the gas with the scrubbing liquid. The bottom portion contained the biogas inlet and therefore served two functions: containing the scrubber liquid and mixing the phases of the scrubber liquid by bubbling of the gas, in addition to facilitating removal of hydrogen sulfide from the gas. The biogas inlet was about 30 mm below the level of the scrubbing liquid. This arrangement formed the gas-liquid counter-current flow in the scrubber, preceded by a short bubbling. The lowest portion contained a conic low part for separation of the aqueous phase, and an outlet placed above the level of phase separation, for recirculation of the scrubbing liquid. The H₂O₂ was injected by controllable pump directly into the recirculation stream towards the top part of the scrubber.

The biogas was blown through the scrubber from the bottom by bubbling through the scrubber liquid reservoir and upwards through the packed-bed section in the middle part of the scrubber. The packed bed contained VFF Pall-Ring packing 25 (Germany). The scrubbing liquid has been supplied from the top onto the contact bed. The scrubber's diameter has been designed for 0.7-1 m/s gas velocity, and the packed bed size permitted 3 seconds retention time. Further parameters are presented below.

The scrubbing liquid was accumulated at the bottom and the ionic liquid phase with unseparated water phase was recycled to the top to be sprayed on top of the packed bed. The biogas flow was kept within the limits of between 0.7-0.9 m/s, yielding between 43-45 cubic meters per hour, providing residence time of about 2.5-3.5 seconds. The scrubbing liquid has been recirculated at a rate of between 50-60 liter per hour. The flow rate of the flue gas and the recirculation rate of the scrubbing liquid were controlled using controllable blower and pump, respectively. The temperature was measured at inlet and outlet, was constant throughout the measurements, at between 25-35° C.

The wet scrubber was loaded with 15 kg of scrubbing liquid which was prepared as follows. Tri(hexyl)(tetradecyl)phosphonium chloride, 12 kg, and 2.4 kg of HBr (48% solution) were mixed at 50° C. for 15 minutes, followed by 1.3 kg of hydrogen peroxide 35% solution. After phase separation two phases were obtained: clear red aqueous phase and clear red ionic liquid phase. Into this mixture, 2.5 kg of sulfuric acid (35% solution) was added. The mixture was stirred at 60° C. for 15 minutes. After phase separation two phases the aqueous phase was clear and colorless, ionic liquid phase was colored in red-orange. The resultant scrubbing liquid composition was as described below:

| Aqueous phase | Ionic liquid phase | |
|---|---|---|
| H₂SO₄ | Br₂ | H₂SO₄ |
| wt % | wt % | wt % |
| 21 | 2.98 | 5.6 |

The hydrogen peroxide solution was supplied into the scrubber into the scrubbing liquid at the lowest part of the scrubber, as a function of H2S concentration at outlet gas and controlled automatically. The average injection rate was 0.6 kg/h of 35% w/v of hydrogen peroxide solution.

The test was run for 3.6 hours. The system was allowed to equilibrate for the first 20 minutes. The outlet H₂S concentration was measured continuously at the scrubber outlet. The inlet H₂S concentration was measured before and in the end of the experiment. A typical inlet concentration was about 1200-1500 ppm, and the typical outlet concentration was between 50 and 60 ppm. The results are presented in the FIG. 5. In the Figure, the efficiency of H₂S removal, calculated as (H₂S in -H₂S out)/H₂S in)*100), is presented at the vertical axis and designated by a caption “yield %”, versus a horizontal axis presenting the time elapsed and designated by a caption “Time (h)”. As it can be seen from the figure, the average process yield (±standard deviation of mean) was 95±4.

The efficiency of the system was tested without supplying the scrubbing liquid to the top, to evaluate the relative part of the bubbling in the scrubbing process. It has been most surprisingly found that the biogas outlet contained only between 200 and 250 ppm of hydrogen sulfide after a brief bubbling via only 30 mm of scrubbing liquid, providing the average yield of about 75 5%.

While the present disclosure has been illustrated and described with respect to a particular embodiment thereof, it should be appreciated by those of ordinary skill in the art that various modifications to this disclosure may be made without departing from the spirit and scope of the present disclosure.

1. A scrubbing liquid useful for decontamination of a gaseous stream from a plurality of contaminants, the scrubbing liquid comprising an aqueous phase and an ionic liquid phase immiscible with said aqueous phase, wherein said ionic liquid phase comprises a water-immiscible ionic liquid, and said aqueous phase comprises water, and further wherein said scrubbing liquid comprises a halogen, a strong acid, and an activating agent.

2. The scrubbing liquid according to claim 1, wherein said water-immiscible ionic liquid is a halide, sulfate, or nitrate salt, of quaternary phosphonium cation of a general formula R¹ₐR²_{b}R³_{c}R⁴_{d}P(⁺), wherein each of R¹ₐ, R²_{b}, R³_{c} and R⁴_{d} is an organic group containing between 1 and a, 1 and b, 1 and c, and 1 and d carbon atoms, respectively, with a, b, c, and d being cardinal numbers, such that the sum of a+b+c+d is between 10 and 60, wherein said water-immiscible ionic liquid has a melting temperature below 50° C., wherein said ionic liquid has a solubility of the ionic liquid in water at room temperature of less than 5% w/w, and wherein said ionic liquid dissolves no more than 10% w/w of water at room temperature.

3. The scrubbing liquid according to claim 2, wherein the R¹ₐ, R²_{b}, R³_{c} and R⁴_{d} groups are same or different and at least two these groups are C5-C15 alkyl groups.

4. The scrubbing liquid according to claim 2, wherein the sum of a+b+c+d is between 25 and 40.

5. The scrubbing liquid according to claim 1, wherein said water-immiscible ionic liquid is a bromide or nitrate of phosphonium cation.

6. The scrubbing liquid according to claim 1, wherein said water-immiscible ionic liquid is tri(hexyl)tetradecyl phosphonium bromide or nitrate.

7. The scrubbing liquid according to claim 1, wherein said halogen consists essentially of bromine.

8. The scrubbing liquid according to claim 1, wherein said halogen is present in a concentration of 1 to 15 weight percent in said ionic liquid phase, and between 0.01 and 3 weight percent in said aqueous phase.

9. The scrubbing liquid according to claim 1, wherein said activating agent is hydrogen peroxide.

10. The scrubbing liquid according to claim 1, wherein the concentration of said activating agent is between 0.01 and 0.7 weight percent in said ionic liquid phase, and between 0.05 and 2 weight percent in said aqueous phase.

11. The scrubbing liquid according to claim 1, wherein said strong acid is a strong mineral acid which comprises sulfuric acid and optionally further comprises an acid selected from the group consisting of nitric acid, phosphoric acid, hydrochloric acid, hydrobromic acid, and hydroiodic acid.

12. The scrubbing liquid according to claim 1, wherein said strong acid is present in said scrubbing liquid in a concentration of between 0.01 and 18 weight percent in said ionic liquid phase, and between 7 and 60 weight percent in said aqueous phase.

13. The scrubbing liquid according to claim 12, wherein said strong acid comprises sulfuric acid that comprises between 0.1 and 9% wt and optionally nitric acid that comprises between 0.1 and 8% wt in said ionic liquid phase, and comprises sulfuric acid that comprises between 7 and 50% wt and optionally nitric acid that comprises between 0.05 and 10% wt in said aqueous phase.

14. The scrubbing liquid according to claim 1, wherein said contaminants are selected from the group consisting of nitric oxide, nitric dioxide, sulfur dioxide, sulfur trioxide, siloxanes, hydrogen sulfide, and heavy metals.

15. The scrubbing liquid according to claim 1, wherein said water-immiscible ionic liquid comprises tri(hexyl)-tetradecyl-phosphonium bromide, said halogen consists essentially of bromine, said strong acid comprises sulfuric acid, and said activating agent comprises hydrogen peroxide, or wherein said water-immiscible ionic liquid comprises tri(hexyl)-tetradecyl-phosphonium nitrate, said halogen consists essentially of bromine, said strong acid comprises sulfuric acid, nitric acid, or mixtures thereof, and said activating agent comprises hydrogen peroxide.

16. The scrubbing liquid according to claim 1, wherein said ionic liquid phase comprises between 80 and 98 weight percent of said scrubbing liquid, and said aqueous phase comprises between 2 and 20 percent of said scrubbing liquid.

17. The scrubbing liquid according to claim 1, wherein said liquid comprises between 80 and 98 weight percent of ionic liquid phase, whereof the halogen comprises between 3 and 10% wt, sulfuric acid comprises between 0.1 and 9% wt, optionally nitric acid comprises between 0.1 and 8% wt, and hydrogen peroxide comprises between 0.05 and 0.7% wt, with the balance of the ionic liquid phase being tri(hexyl)-tetradecyl-phosphonium bromide or nitrate, and further the scrubbing liquid comprises between 2 and 20 weight percent of the aqueous phase, whereof the halogen comprises between 0.01 and 3% wt, sulfuric acid comprises between 7 and 50% wt, optionally nitric acid comprises between 0.05 and 10% wt, and hydrogen peroxide comprises between 0.05 and 2% wt, with the balance of the aqueous phase being water.

18. A method for decontaminating of a contaminated gaseous stream contaminated with one or more contaminants, by contacting said contaminated gaseous stream with a scrubbing liquid according to claim 1, to obtain at least partially decontaminated gaseous stream.

19. The method according to claim 18, wherein said contaminated gaseous stream is a natural sour gas, a biogas, or a flue gas resulting from fuel burning or incinerating of combustible substrates.

1. A scrubbing liquid useful for decontamination of a gaseous stream from a plurality of contaminants, the scrubbing liquid comprising an aqueous phase and an ionic liquid phase immiscible with said aqueous phase, wherein said ionic liquid phase comprises a water-immiscible ionic liquid, and said aqueous phase comprises water, and further wherein said scrubbing liquid comprises a halogen, a strong acid, and an activating agent.

2. The scrubbing liquid according to claim 1, wherein said water-immiscible ionic liquid is a halide, sulfate, or nitrate salt, of quaternary phosphonium cation of a general formula R¹ₐR²_{b}R³_{c}R⁴_{d}P(⁺), wherein each of R¹ₐ, R²_{b}, R³_{c} and R⁴_{d} is an organic group containing between 1 and a, 1 and b, 1 and c, and 1 and d carbon atoms, respectively, with a, b, c, and d being cardinal numbers, such that the sum of a+b+c+d is between 10 and 60, wherein said water-immiscible ionic liquid has a melting temperature below 50° C., wherein said ionic liquid has a solubility of the ionic liquid in water at room temperature of less than 5% w/w, and wherein said ionic liquid dissolves no more than 10% w/w of water at room temperature.

3. The scrubbing liquid according to claim 2, wherein the R¹ₐ, R²_{b}, R³_{c} and R⁴_{d} groups are same or different and at least two these groups are C5-C15 alkyl groups.

4. The scrubbing liquid according to claim 2, wherein the sum of a+b+c+d is between 25 and 40.
